(19) United States
(12) Patent Application Publication
(10) Pub. No.: US 2026/0057295 A1
(43) Pub. Date: Feb. 26, 2026

(54) LARGE LANGUAGE MODEL (LLM) AS A PROXY FOR UNDERSTANDING GROUP DYNAMICS

(71) Applicant: Honda Motor Co., Ltd., Tokyo (JP)

(72) Inventors: Yubin KIM, Cambridge, MA (US); Hifza JAVED, Fremont, CA (US); Nawid JAMALI, San Francisco, CA (US)

(21) Appl. No.: 19/096,132

(22) Filed: Mar. 31, 2025

Related U.S. Application Data
(60) Provisional application No. 63/686,362, filed on Aug. 23, 2024.

(51) Int. Cl. G06N 20/00; G06F 40/30

(52) U.S. Cl. CPC G06N 20/00; G06F 40/30

(57) ABSTRACT

According to one aspect, using a large language model (LLM) as a proxy for understanding group dynamics may include, for a given participant of a conversation, instantiating a corresponding LLM and initializing the corresponding LLM as a proxy based on participant information corresponding to the given participant, shaping and adapting the corresponding LLM based on an observation of the given participant during the conversation, and self-calibrating the corresponding LLM based on querying the corresponding LLM using information associated with a scenario and an observation of a response of the given participant to the scenario.

### CROSS REFERENCE TO RELATED APPLICATIONS

This application claims the benefit of U.S. Provisional Patent Application, Ser. No. 63/686,362 (Attorney Docket No. H1241981US01) entitled “GROUPMIND: LARGE LANGUAGE MODEL (LLM) AS PERSONAL PROXY FOR UNDERSTANDING GROUP DYNAMICS”, filed on Aug. 23, 2024; the entirety of the above-noted application(s) is incorporated by reference herein.

### BACKGROUND

A large language model (LLM) is a type of machine learning model designed for natural language processing tasks such as language generation. LLMs are language models with many parameters, and are trained with self-supervised learning on a vast amount of text. The largest and most capable LLMs are generative pretrained transformers (GPTs). Modern models can be fine-tuned for specific tasks or guided by prompt engineering. These models acquire predictive power regarding syntax, semantics, and ontologies inherent in human language corpora, but they also inherit inaccuracies and biases present in the data they are trained in.

### BRIEF DESCRIPTION

According to one aspect, a system for using a large language model (LLM) as a proxy for understanding group dynamics may include a memory and a processor. The memory may store one or more instructions. The processor may execute one or more of the instructions stored on the memory to perform, for a given participant of a conversation, one or more acts, actions, and/or steps. The processor may instantiate a corresponding LLM and initialize the corresponding LLM as a proxy based on participant information corresponding to the given participant. The processor may shape and adapt the corresponding LLM based on an observation of the given participant during the conversation. The processor may self-calibrate the corresponding LLM based on querying the corresponding LLM using information associated with a scenario and an observation of a response of the given participant to the scenario.

The participant information may include demographic information, previous interactions, a role, or a goal associated with the given participant. The observation of the given participant during the conversation may include a response of the given participant to an utterance. The processor may shape and adapt the corresponding LLM for a predefined number of turns or until a consensus is reached. The processor may self-calibrate the corresponding LLM by determining a semantic similarity between an output of the query to the corresponding LLM using information associated with the scenario and the observation of the response of the given participant to the scenario. The semantic similarity may be measured based on a cosine difference.

The processor may identify a potential conflict between the given participant and another participant based on the self-calibrated corresponding LLM for the given participant. The processor may enhance communication between the given participant and another participant based on the self-calibrated corresponding LLM for the given participant. The processor may optimize collaboration between the given participant and another participant based on the self-calibrated corresponding LLM for the given participant. The system for using a large language model (LLM) as a proxy for understanding group dynamics may include a robot including an actuator and an output device. The actuator or the output device of the robot may be activated based on the self-calibrated corresponding LLM for the given participant.

According to one aspect, a computer-implemented method for using a large language model (LLM) as a proxy for understanding group dynamics may include, for a given participant of a conversation, instantiating a corresponding LLM and initializing the corresponding LLM as a proxy based on participant information corresponding to the given participant, shaping and adapting the corresponding LLM based on an observation of the given participant during the conversation, and self-calibrating the corresponding LLM based on querying the corresponding LLM using information associated with a scenario and an observation of a response of the given participant to the scenario.

The participant information may include demographic information, previous interactions, a role, or a goal associated with the given participant. The observation of the given participant during the conversation may include a response of the given participant to an utterance. The computer-implemented method for using a large language model (LLM) as a proxy for understanding group dynamics may include shaping and adapting the corresponding LLM for a predefined number of turns or until a consensus is reached. The self-calibrating the corresponding LLM may include determining a semantic similarity between an output of the query to the corresponding LLM using information associated with the scenario and the observation of the response of the given participant to the scenario.

According to one aspect, a system for using a large language model (LLM) as a proxy for understanding group dynamics may include a memory and a processor. The memory may store one or more instructions. The processor may execute one or more of the instructions stored on the memory to perform, for a given participant of a conversation, one or more acts, actions, and/or steps. The processor may instantiate a corresponding LLM and initialize the corresponding LLM as a proxy based on participant information corresponding to the given participant. The processor may shape and adapt the corresponding LLM based on an observation of the given participant during the conversation. The processor may self-calibrate the corresponding LLM by determining a semantic similarity between an output of a query to the corresponding LLM using information associated with a scenario and an observation of a response of the given participant to the scenario.

The participant information may include demographic information, previous interactions, a role, or a goal associated with the given participant. The observation of the given participant during the conversation may include a response of the given participant to an utterance. The processor may shape and adapt the corresponding LLM for a predefined number of turns or until a consensus is reached. The semantic similarity may be measured based on a cosine difference.

### BRIEF DESCRIPTION OF THE DRAWINGS

FIG. 1 is an exemplary component diagram of a system for using a large language model (LLM) as a proxy for understanding group dynamics, according to one aspect.

FIG. 2 is an exemplary flow diagram of a computer-implemented method for using a large language model (LLM) as a proxy for understanding group dynamics, according to one aspect.

FIG. 3 is an exemplary flow diagram of a computer-implemented method for using a large language model (LLM) as a proxy for understanding group dynamics, according to one aspect.

FIG. 4 is an exemplary scenario associated with using a large language model (LLM) as a proxy for understanding group dynamics, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

An “agent”, as used herein, may be a machine or a model that emulates an individual or a participant in a conversation or interaction between multiple individuals. Exemplary agents may include robots or other self-operating machines.

“Interpersonal Agreeableness”, as used herein, may be an extent to which an individual is perceived as friendly, approachable, and considerate in their interactions with others. The “Interpersonal Agreeableness” may be assessed on a 15-point Likert scale, ranging from ‘disagreeable (−7)’ (coldness, aloofness, and unfriendliness) to ‘agreeable (+7)’ (warmth, friendliness, and pleasantness).

“Affect”, as used herein, may be a collective term for describing feeling states like emotions and moods.

“Group Affect”, as used herein, may be a collective-level affect, representative of the group as a collection of individuals.

A “Large Language Model” or “LLM”, as used herein, may include an advanced artificial intelligence system that uses deep learning techniques to understand and generate human language, enabling them to perform a variety of natural language processing tasks.

LLMs may be integrated with multimodal data inputs, such as audio, visual, text, etc., capturing exchanges of behavioral cues between members of a group. In this context, ‘group’ may be used broadly to refer to two or more individuals engaged with one another, regardless of whether they are acquainted or not. As described herein, using the LLM as a proxy for understanding group dynamics may enable an estimation or a prediction of interpersonal affects using the LLM as a proxy for an agent of a conversation, thereby enabling an estimation of a group affect. The conversation may include multiple participants, and thus, multiple agents (e.g., a first agent, a second agent, a third agent, etc.) may be instantiated. For each participant, the LLM may be instantiated and initialized based on corresponding participant information. In this way, an LLM instantiated and initiated as a proxy may represent one of the humans in the conversation and mimic or model human behavior so that the LLM may interpret interpersonal perception or interpersonal affect from the perspective of that person as they interact with other humans. Interactions may include behaviors, dialogue, utterances, etc. After the LLM is instantiated and initiated, the LLM may be shaped or adapted based on ongoing observations of the corresponding participant or human in response to different scenarios.

In this way, the framework and system for using the LLM as a proxy for understanding group dynamics may leverage LLMs to create intelligent agent proxies that represent individual group members, utilizing inputs such as personality information, conversation history, non-verbal cues, and data from recorded audio or video, including acoustic features and/or speech transcription. By integrating these modalities, the system for using the LLM as a proxy for understanding group dynamics may construct a real-time, nuanced understanding of each individual within the context of the interaction, thereby capturing the essence of group dynamics.

Using the LLM as a proxy for understanding group dynamics facilitates nuanced analysis of group dynamics. Beneficially and advantageously, the LLM may be used in many downstream tasks, such as estimating how agreeable one individual perceives one or more other interactants in the group, estimating potential conflict between interactants, group sentiment analysis, role assignment, and mediation assistance, including robot-assisted mediation, enabling effective real-time mediation and feedback through a moderator agent to foster diversity and inclusion, improving patient-staff dynamics in healthcare settings, etc.

As the personal proxies learn and adapt by observing group conversations, the LLMs may adapt and improve their understanding of the group dynamics over time and may be employed as mediators to refine interactions and foster collaboration, according to one aspect. This offers significant advancements over other approaches by providing deep insights into interpersonal dynamics and leveraging self-improving proxies for better group performance.

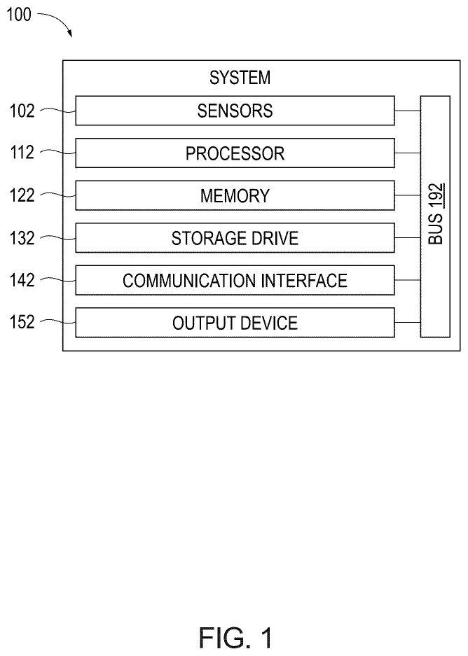

FIG. 1 is an exemplary component diagram of a system 100 for using a large language model (LLM) as a proxy for understanding group dynamics, according to one aspect. The system 100 for using the LLM as a proxy for understanding group dynamics may include one or more sensors 102, a processor 112, a memory 122, a storage drive 132, a communication interface 142, an output device 152, and a bus 192. The bus 192 may form an operable connection between one or more of the respective components (e.g., one or more of the sensors 102, the processor 112, the memory 122, the storage drive 132, the communication interface 142, the output device 152) of the system 100 for using the LLM as a proxy for understanding group dynamics and enabling computer communication therebetween. According to one aspect, the system 100 for using the LLM as a proxy for understanding group dynamics may be implemented on a mobile device, such as a smartphone.

The one or more sensors 102 may be a microphone, a camera, an image capture device, etc. In any event the one or more sensors 102 may record, detect, or sense aspects related to an interaction or a conversation between participants.

The memory 122 may store one or more instructions. The processor 112 may execute one or more of the instructions stored on the memory 122 to perform, for a given participant of a conversation, one or more acts, actions, and/or steps. The communication interface 142 may receive the LLM from a remote server or from the cloud. The storage drive 132 may store the LLM local to the system 100 for using the LLM as a proxy for understanding group dynamics as shaped, adapted, and/or calibrated.

### Proxy Agent Representation

Each participant in the group may be represented by a proxy agent or an LLM-based entity designed to mimic the communication style and preferences of an individual or participant. The proxy agent's role may include analyzing the participant's historical data and ongoing interactions to generate responses that reflect the participant's typical behavior and sentiment. The system may start from scratch, and gather information and knowledge in real-time during the interaction, which may be stored in the memory 122 or the storage drive 132. In subsequent encounters, the system 100 may not necessarily start from scratch and may utilize existing information and knowledge from previous interactions, stored in the memory 122 or storage drive 132, to enhance its understanding and prediction of participant behavior when the individual is encountered again.

### Dynamic Interaction Modeling

The framework employs a dynamic approach to interaction modeling, allowing for real-time updates and adjustments based on the flow of conversation and evolving group dynamics and may include agent instantiation and initialization, shaping or contextual adaptation, and self-calibration of the LLM for each participant in a conversation.

### Instantiation

The processor 112 may instantiate a corresponding LLM and initialize the corresponding LLM as a proxy based on participant information corresponding to the given participant. This LLM may be the proxy to the given or corresponding agent. The participant information may include demographic information (e.g., age, gender, ethnicity, hometown, current location, political inclinations, etc.), previous interactions, a role, or a goal associated with the given participant. According to one aspect, the LLM may be preloaded with demographic data or other pre-learned data.

Explained another way, the processor 112 may set up proxy agents with baseline data and interaction history. Each agent may be instantiated as a LLM that is pre-loaded with demographic data, previous interaction logs, and predefined roles and goals specific to the participant it represents. This information forms a foundational context that guides the agent's initial responses and behavior.

### Shaping (Contextual Adaptation)

The processor 112 may shape and contextually adapt the corresponding LLM based on an observation of the given participant during the conversation. As discussed above, one or more of the sensors 102 may record, detect, or sense the observation and/or the conversation. The processor 112 may shape and adapt the corresponding LLM for a predefined number of turns or until a consensus is reached. In other words, the LLM may be adapted based on observations of the participant during interactions with others, thereby ‘shaping’ the LLM according to interaction history of the human corresponding to the given participant and how that person behaves in a social interaction with another person. In this way, the LLM may be adapted or learn more about the humans in the conversation as the conversation evolves. Thus, the LLM may act as an intelligent agent proxy and thus emulate individual participants or the conversation or interaction, facilitating a realistic and contextually aware understanding of group interactions.

Explained yet another way, the processor 112 may continuously update agent behavior based on new data and interactions. As conversations progress, each agent-LLM absorbs new information, adapts its strategies, and modifies its responses to align more closely with the evolving context of the interaction. This process ensures that the agent remains relevant and accurately reflective of the ongoing dynamics.

### Self-Calibration

The processor 112 may self-calibrate the corresponding LLM based on querying the corresponding LLM using information associated with a scenario and an observation of a response of the given participant to the scenario. According to one aspect, one or more of the sensors 102 may record, detect, or sense the response. The processor 112 may self-calibrate the corresponding LLM by determining a semantic similarity between an output of the query to the corresponding LLM using information associated with the scenario and the observation of the response of the given participant to the scenario. The semantic similarity may be measured based on a cosine difference or a distance between sentiments. In this way, self-calibration enables the LLM to align itself with what a human actually said or how the human actually responded.

Explained another way, for example, the LLM may predict or generate an utterance that the LLM predicts a human corresponding to the given participant would have reacted to a scenario. The processor 112 may compare that prediction with the actual utterance produced by the human and perform self-calibration accordingly, thereby enabling agents to refine their mimicry and response generation over time. When semantic similarity falls below a predefined threshold, agents may be prompted with actual and synthesized utterances to enhance their ability to mimic the participant more accurately. This iterative feedback mechanism allows agents to self-adjust and improve their conversational fidelity.

The observation of the given participant during the conversation may include a response of the given participant to an utterance. Again, one or more of the sensors 102 may record, detect, or sense the utterance.

The processor 112 may identify a potential conflict between the given participant and another participant based on the self-calibrated corresponding LLM for the given participant. The processor 112 may enhance communication between the given participant and another participant based on the self-calibrated corresponding LLM for the given participant. The processor 112 may optimize collaboration between the given participant and another participant based on the self-calibrated corresponding LLM for the given participant. For example, the processor 112 may achieve any one of these by querying the LLM with a corresponding query (e.g., “what potential conflict do you have with XYZ”, “how can we improve communication between you and XYZ”, “how can we improve collaboration between you and XYZ”, “summarize your thoughts on XYZ”, etc.), where XYZ may be a human, a participant, a topic, etc. In this way, group dynamic estimation may be provided, using the self-calibrated LLM.

Given the observed interactions, the proxies (e.g., LLM) may simulate future actions by querying the LLM. This enables the LLM to emulate or predict future (e.g., subsequent) behaviors, including the generation of verbal and non-verbal responses that are semantically equivalent to those of the actual participants' future behavior. In addition to predicting behavior, these proxies may be queried to answer questions related to the downstream task. For example, an embodied mediator could inquire about a participant's level of agreeability towards another participant from the proxy. This information could then be used to mediate the interaction.

### Output and Refinement

The system 100 for using a large language model (LLM) as a proxy for understanding group dynamics may include an output device 152 which may be a robot including an actuator. The actuator of the robot or the output device 152 may be activated based on the self-calibrated corresponding LLM for the given participant.

The framework may also introduce a moderator agent to enhance the mediation and refinement process during group interactions. According to one aspect, the moderator may be another LLM agent, and may play a role in optimizing communication and group dynamics by providing feedback to each proxy agent. Unlike the proxy agents, which primarily have access to the interaction history and real-time data relevant to the individual they represent, the moderator may be equipped with additional information, such as actual label information and demographic data for all participants. This information disparity allows the moderator to make more informed decisions, anticipate potential issues, and guide the proxies towards more effective communication strategies.

Using the LLM as a proxy for understanding group dynamics is particularly beneficial in complex scenarios where direct proxy-to-proxy interactions might not suffice in maintaining group cohesion or resolving conflicts. The moderator's broader perspective enables it to detect subtleties in the interactions that might be missed by the individual proxies, thereby enhancing the overall quality of the mediation process.

According to one aspect, the moderator agent may:

Identify Potential Conflicts: utilizing its comprehensive access to participant information, the moderator may detect early signs of disagreement or tension within the group, allowing for timely interventions.

Enhance Communication: by leveraging additional data, the moderator may provide continuous feedback to participants on their communication style, encouraging adaptations that promote more effective dialogue.

Optimize Collaboration: the moderator may analyze interaction patterns from a macro-level perspective to suggest strategies for improving group cohesion and collaborative efficiency, taking into account the unique attributes of each participant.

### Potential Applications

The insights gained from the framework have broad applications across multiple domains, including:

Organizational Behavior: enhancing team dynamics in workplace settings by modeling and adjusting team interactions dynamically.

Social Psychology: studying interpersonal relationships in various social contexts through detailed behavioral modeling and adaptive feedback mechanisms.

Human-Computer Interaction: improving the design of interactive systems for group work by incorporating real-time behavioral adaptation and group dynamics insights.

Human-Human-Robot Interaction: informing behavior generation for a social mediator robot that must take appropriate actions to improve social dynamics in a real-world group interaction involving multiple individuals.

Thus, the system 100 for using the LLM as a proxy for understanding group dynamics framework may advance the modeling of group dynamics by utilizing LLMs to understand individual and group interactions with unprecedented detail. Unlike previous models, the system 100 for using the LLM as a proxy for understanding group dynamics may leverage multimodal data inputs to capture the complex interplay of verbal and non-verbal interactions. This provides the benefit of allowing for a dynamic understanding of group interactions, enabling real-time mediation and refinement of interactions.

Existing models primarily focus on non-verbal cues and cannot accurately simulate the individual contributions and verbal exchanges that are vital to understanding group dynamics. The system 100 for using the LLM as a proxy for understanding group dynamics addresses these limitations by using LLMs as intelligent proxies for group members, providing a comprehensive analysis of both group-level and individual-level dynamics. By integrating multimodal data inputs and leveraging intelligent agent proxies, the system may provide a comprehensive analysis of group interactions, paving the way for improved collaboration and communication in various fields.

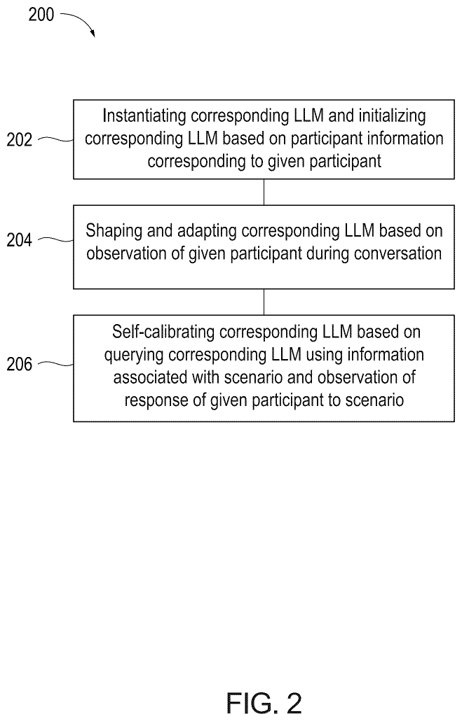

FIG. 2 is an exemplary flow diagram of a computer-implemented method for using a large language model (LLM) as a proxy for understanding group dynamics, according to one aspect. The computer-implemented method for using the LLM as a proxy for understanding group dynamics may include, for a given participant of a conversation, instantiating a corresponding LLM and initializing 202 the corresponding LLM based on participant information corresponding to the given participant, shaping and adapting 204 the corresponding LLM based on an observation of the given participant during the conversation, and self-calibrating 206 the corresponding LLM based on querying the corresponding LLM using information associated with a scenario and an observation of a response of the given participant to the scenario.

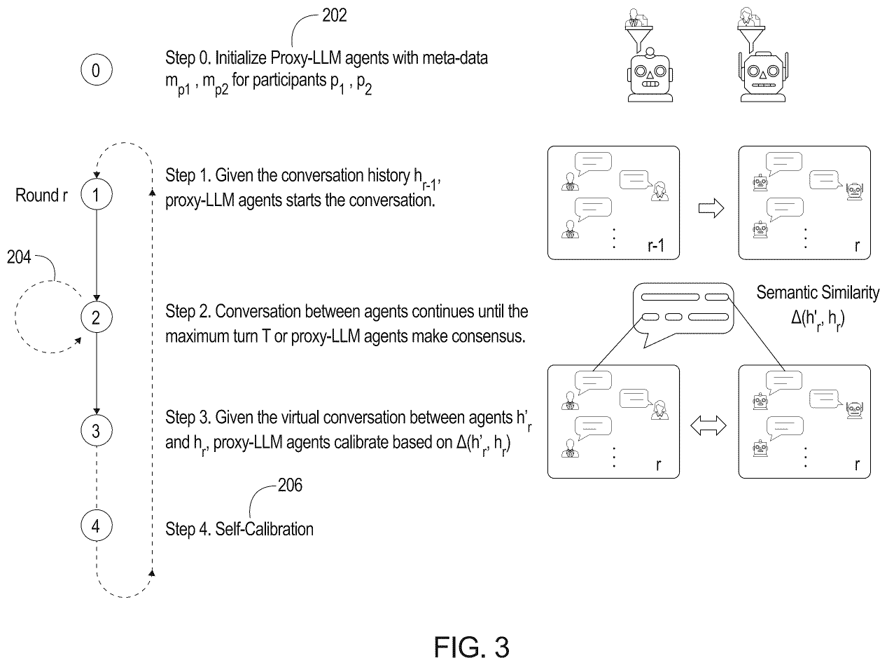

FIG. 3 is an exemplary flow diagram of a computer-implemented method for using a large language model (LLM) as a proxy for understanding group dynamics, according to one aspect. As seen in FIG. 3, a pipeline for modeling and optimizing agreeableness in group interactions using proxy-LLMs is provided. At step 0, the processor may initialize 202 each proxy-LLM agent with meta-data mₚ_{₁}, mₚ_{₂} corresponding to participants p₁, p₂, equipping them with personalized information to accurately represent each individual. At step 1, the proxy-LLM agents may commence the conversation based on prior interaction history hᵣ₋₁, setting the context for the current round of dialogue and shaping itself 204. At step 2, dialogue between the agents may continue, guided by a pre-defined maximum number of turns T or until a consensus is reached. This process may dynamically adjust the conversation course based on evolving participant responses. At step 3, the processor may follow the virtual conversation hᵣ, h′ᵣ, and each proxy-LLM may self-calibrate 206 its responses and strategies by analyzing the semantic similarity Δh′(r, hᵣ), ensuring that the proxies evolve and adapt to the interaction nuances and agreeableness shifts observed in the dialogue.

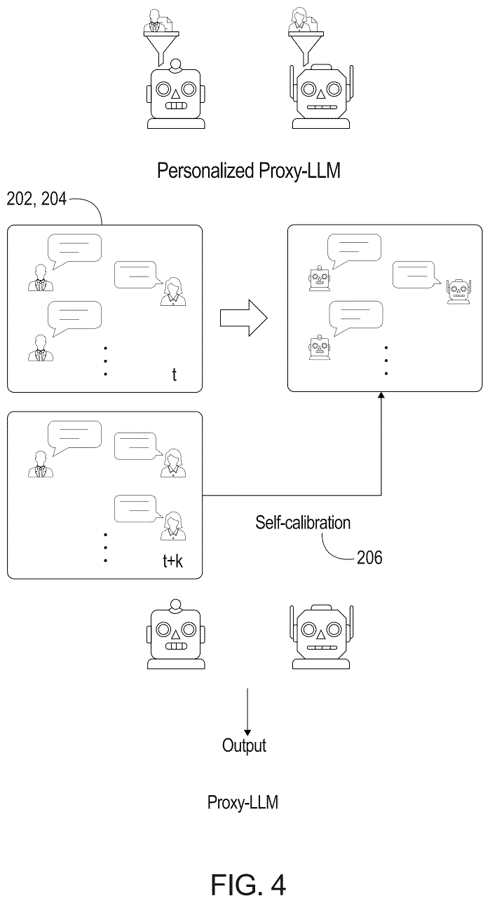

FIG. 4 is an exemplary scenario associated with using a large language model (LLM) as a proxy for understanding group dynamics, according to one aspect. In FIG. 4, personalized proxy LLMs may represent each participant, and may be initialized 202 with historical data to better mimic individual communication styles. These proxies or proxy-LLMs may self-calibrate 206 based on continuous interaction 204, enhancing prediction accuracy over time. Again, the LLM may predict or generate a prediction or how the LLM predicts a human corresponding to the given participant would have reacted to a scenario. The processor 112 may compare that prediction with the actual utterance produced by the human and perform self-calibration 206 accordingly.

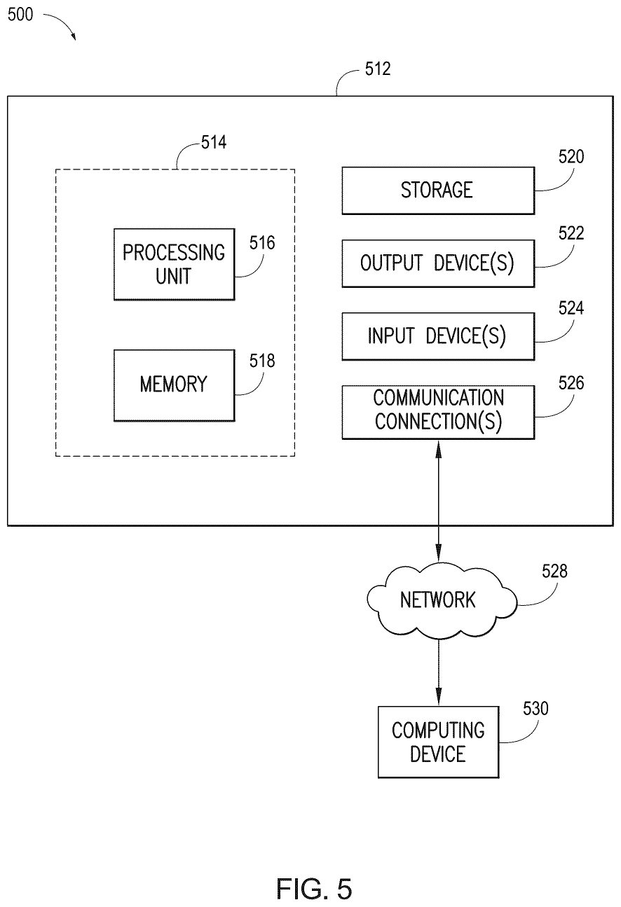

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, which perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

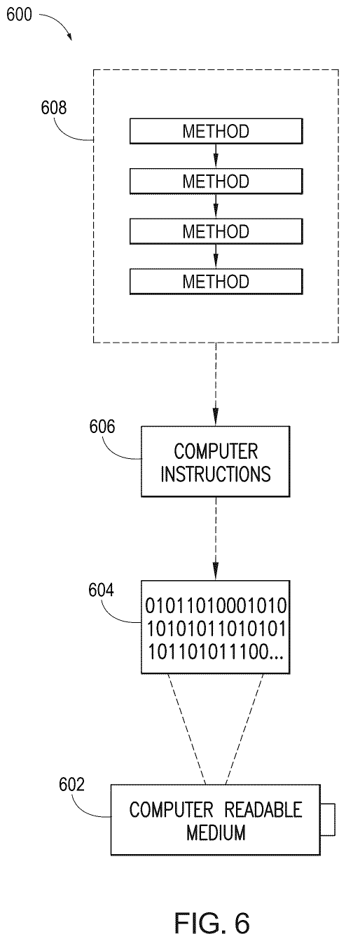

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 200 for using a large language model (LLM) as a proxy for understanding group dynamics of FIG. 2. In another aspect, the processor-executable computer instructions 606 may be configured to implement a system, such as the system 100 for using large language model (LLM) as a proxy for understanding group dynamics of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for using a large language model (LLM) as a proxy for understanding group dynamics, comprising:
a memory storing one or more instructions; and
a processor executing one or more of the instructions stored on the memory to perform, for a given participant of a conversation:
instantiating a corresponding LLM and initializing the corresponding LLM as a proxy based on participant information corresponding to the given participant;
shaping and adapting the corresponding LLM based on an observation of the given participant during the conversation; and
self-calibrating the corresponding LLM based on querying the corresponding LLM using information associated with a scenario and an observation of a response of the given participant to the scenario.

2. The system for using a large language model (LLM) as a proxy for understanding group dynamics of claim 1, wherein the participant information includes demographic information, previous interactions, a role, or a goal associated with the given participant.

3. The system for using a large language model (LLM) as a proxy for understanding group dynamics of claim 1, wherein the observation of the given participant during the conversation includes a response of the given participant to an utterance.

4. The system for using a large language model (LLM) as a proxy for understanding group dynamics of claim 1, wherein the processor performs the shaping and adapting of the corresponding LLM for a predefined number of turns or until a consensus is reached.

5. The system for using a large language model (LLM) as a proxy for understanding group dynamics of claim 1, wherein the self-calibrating the corresponding LLM includes determining a semantic similarity between an output of the query to the corresponding LLM using information associated with the scenario and the observation of the response of the given participant to the scenario.

6. The system for using a large language model (LLM) as a proxy for understanding group dynamics of claim 5, wherein the semantic similarity is measured based on a cosine difference.

7. The system for using a large language model (LLM) as a proxy for understanding group dynamics of claim 1, wherein the processor identifies a potential conflict between the given participant and another participant based on the self-calibrating corresponding LLM for the given participant.

8. The system for using a large language model (LLM) as a proxy for understanding group dynamics of claim 1, wherein the processor enhances communication between the given participant and another participant based on the self-calibrating corresponding LLM for the given participant.

9. The system for using a large language model (LLM) as a proxy for understanding group dynamics of claim 1, wherein the processor optimizes collaboration between the given participant and another participant based on the self-calibrating corresponding LLM for the given participant.

10. The system for using a large language model (LLM) as a proxy for understanding group dynamics of claim 1, comprising a robot including an actuator and an output device, wherein the actuator or the output device of the robot is activated based on the self-calibrating corresponding LLM for the given participant.

11. A computer-implemented method for using a large language model (LLM) as a proxy for understanding group dynamics, comprising:
for a given participant of a conversation:
instantiating a corresponding LLM and initializing the corresponding LLM as a proxy based on participant information corresponding to the given participant;
shaping and adapting the corresponding LLM based on an observation of the given participant during the conversation; and
self-calibrating the corresponding LLM based on querying the corresponding LLM using information associated with a scenario and an observation of a response of the given participant to the scenario.

12. The computer-implemented method for using a large language model (LLM) as a proxy for understanding group dynamics of claim 11, wherein the participant information includes demographic information, previous interactions, a role, or a goal associated with the given participant.

13. The computer-implemented method for using a large language model (LLM) as a proxy for understanding group dynamics of claim 11, wherein the observation of the given participant during the conversation includes a response of the given participant to an utterance.

14. The computer-implemented method for using a large language model (LLM) as a proxy for understanding group dynamics of claim 11, comprising performing the shaping and adapting of the corresponding LLM for a predefined number of turns or until a consensus is reached.

15. The computer-implemented method for using a large language model (LLM) as a proxy for understanding group dynamics of claim 11, wherein the self-calibrating the corresponding LLM includes determining a semantic similarity between an output of the query to the corresponding LLM using information associated with the scenario and the observation of the response of the given participant to the scenario.

16. A system for using a large language model (LLM) as a proxy for understanding group dynamics, comprising:
a memory storing one or more instructions; and
a processor executing one or more of the instructions stored on the memory to perform, for a given participant of a conversation:
instantiating a corresponding LLM and initializing the corresponding LLM as a proxy based on participant information corresponding to the given participant;
shaping and adapting the corresponding LLM based on an observation of the given participant during the conversation; and
self-calibrating the corresponding LLM by determining a semantic similarity between an output of a query to the corresponding LLM using information associated with a scenario and an observation of a response of the given participant to the scenario.

17. The system for using a large language model (LLM) as a proxy for understanding group dynamics of claim 16, wherein the participant information includes demographic information, previous interactions, a role, or a goal associated with the given participant.

18. The system for using a large language model (LLM) as a proxy for understanding group dynamics of claim 16, wherein the observation of the given participant during the conversation includes a response of the given participant to an utterance.

19. The system for using a large language model (LLM) as a proxy for understanding group dynamics of claim 16, wherein the processor performs the shaping and adapting of the corresponding LLM for a predefined number of turns or until a consensus is reached.

20. The system for using a large language model (LLM) as a proxy for understanding group dynamics of claim 16, wherein the semantic similarity is measured based on a cosine difference.
